(19) United States
(12) Patent Application Publication
(10) Pub. No.: US 2024/0355061 A1
(43) Pub. Date: Oct. 24, 2024

(54) AUGMENTED REALITY BASED COMPARATIVE LEARNING OF MACHINE FUNCTIONALITY

(71) Applicant: International Business Machines Corporation, Armonk, NY (US)

(72) Inventors: Jeremy R. Fox, Georgetown, TX (US); Randy A. Rendahl, Raleigh, NC (US); Tushar Agrawal, West Fargo, ND (US); Sarbajit K. Rakshit, KOLKATA (IN)

(21) Appl. No.: 18/302,036

(22) Filed: Apr. 18, 2023

(51) Int. Cl. G06T 19/00; G09B 25/02

(52) U.S. Cl. CPC G06T 19/006; G09B 25/02

(57) ABSTRACT

Embodiments are related to augmented reality based comparative learning of machine functionality. An augmented reality (AR) device identifies that a new action is to be performed on a first machine, the first machine being viewable by a user using the AR device, where the new action is configured to be performed by the user using at least one component of the first machine. The AR device obtains a digital representation of a second machine, the digital representation being associated with an equivalent action to the new action. A first outcome of the new action and a second outcome of the equivalent action are determined to be equivalent. The AR device displays the equivalent action of the digital representation of the second machine overlaid on the first machine such that the equivalent action of the digital representation is viewable to the user.

### BACKGROUND

The present invention generally relates to computer systems, and more specifically, to computer-implemented methods, computer systems, and computer program products configured and arranged for providing augmented reality based comparative learning of machine functionality.

Virtual reality (VR) or augmented reality (AR) environments have been around for a number of years. VR or AR may refer to simulated environments featuring computer graphics that a user can interact with in a way that is more immersive than merely watching a television or computer screen. In typical VR environments, the user would typically utilize some external set of controllers, such as a joystick or interactive glove, in order to move around in the VR environment. Other implementations of VR have included VR goggles, which are head-mounted devices that a user only needs to wear over his/her eyes. The user can then see the equivalent of a panoramic view, and the user may manipulate the environment seen through the goggles by using some external device, like a joystick or some other controller. AR implementations blend computer graphics and other images with a user's actual surroundings, such that the user may perceive that his/her surroundings have been augmented. To achieve this, AR goggles that the user may wear typically provide transparent or substantially transparent lenses, so that the user can still see his/her actual surroundings while viewing other virtual objects at the same time.

### SUMMARY

Embodiments of the present invention are directed to computer-implemented methods for providing augmented reality based comparative learning of machine functionality. A non-limiting computer-implemented method includes identifying, by an augmented reality (AR) device, that a new action is to be performed on a first machine, the first machine being viewable by a user using the AR device, where the new action is configured to be performed by the user using at least one component of the first machine. The computer-implemented method includes obtaining, by the AR device, a digital representation of a second machine, the digital representation being associated with an equivalent action to the new action. A first outcome of the new action and a second outcome of the equivalent action are determined to be equivalent. The computer-implemented method includes displaying, by the AR device, the equivalent action of the digital representation of the second machine overlaid on the first machine such that the equivalent action of the digital representation is viewable to the user.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of the example computing environment configured for providing augmented reality based comparative learning of machine functionality according to one or more embodiments of the present invention;

FIG. 3 depicts a block diagram of the example computing environment configured with further details for providing augmented reality based comparative learning of machine functionality according to one or more embodiments of the present invention;

FIG. 4 is a flowchart of a computer-implemented method for discovering an original process for the augmented reality based comparative learning of machine functionality according to one or more embodiments of the present invention;

FIG. 5 is a flowchart of a computer-implemented method for deriving a new process for the augmented reality based comparative learning of machine functionality according to one or more embodiments of the present invention;

FIG. 6 is a flowchart of a computer-implemented method for providing guidance to a worker using the augmented reality based comparative learning of machine functionality according to one or more embodiments of the present invention;

FIG. 7 is a flowchart of a computer-implemented method for updating guidance to the worker for the augmented reality based comparative learning of machine functionality according to one or more embodiments of the present invention;

FIG. 8 depicts a block diagram of an example original machine and an example new machine utilized for augmented reality based comparative learning of machine functionality according to one or more embodiments of the present invention;

FIG. 9A depicts a block diagram of an example original machine for augmented reality based comparative learning of machine functionality according to one or more embodiments of the present invention;

FIG. 9B depicts a block diagram of an example new machine utilized for augmented reality based comparative learning of machine functionality according to one or more embodiments of the present invention; and

FIG. 10 is a flowchart of a computer-implemented method for providing augmented reality based comparative learning of machine functionality according to one or more embodiments of the present invention.

### DETAILED DESCRIPTION

One or more embodiments of the invention describe computer-implemented methods, computer systems, and computer program products configured and arranged to provide augmented reality (AR) based comparative learning of machine functionality. When a user wishes to learn a new technology or learn a new way of performing any activity such as, for example, learning to operate an advanced machine, etc., one or more embodiments are configured to use an AR device to provide reference to past knowledge for performing a previous activity for the user in association with viewing the new technology for performing the new activity. The reference can be provided by, for example, images, video, and/or audio output by the AR device. This allows the user to quickly map his/her past knowledge or experience of the previous activity/knowledge to the new activity of the new technology. This helps the user to reduce the learning cycle for the new activity on the new technology.

According to one or more embodiments, using the AR device, the user can view the new technology in the physical surrounding of the real world while digital content of the past knowledge for performing the previous action is overlaid on the physical surrounding of the new technology. In many instances, a person is habituated with the existing way of performing any activity, so that the person follows a particular workflow, sequence of procedures, sequence of steps, etc., which are captured or obtained by the disclosed system. The user may be tasked with using a new way of performing any activity, in which the new way of performing the activity requires the user to spend an enormous time to learn new technology.

According to one or more embodiments, the disclosed system can identify how different functionalities are executed and what outcomes are produced with the current set of equipment. The disclosed system can identify and project via augmented reality to a user how the same can be achieved with a newer set of equipment by improving efficiency, throughput, etc. The disclosed system can leverage digital twins to create simulation for the current and newer equipment and compare them to provide this analysis. The AR device projects how a worker is allowed to map his knowledge of the current machine to the newer machine and how to bridge the skill gap and training needs. Further, the AR device instructs the worker about the tasks that are not relevant in the newer equipment, the new tasks needed, and/or the tasks needed with some modifications. Additionally, the disclosed system will further enforce injecting resiliency in the process with the upgraded/newer machine and newer/safer ways of executing an activity.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as packet optimization code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

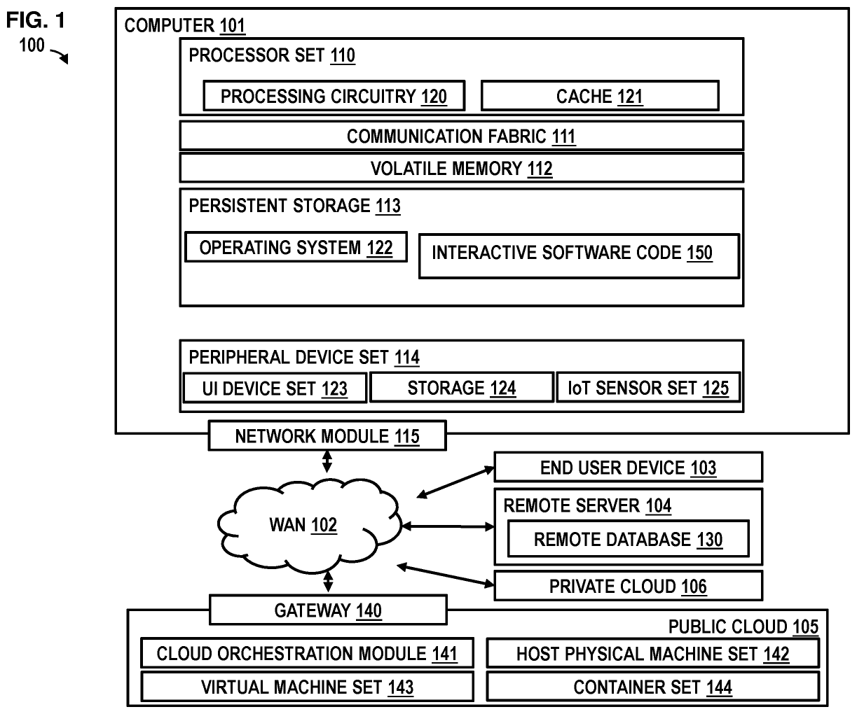

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

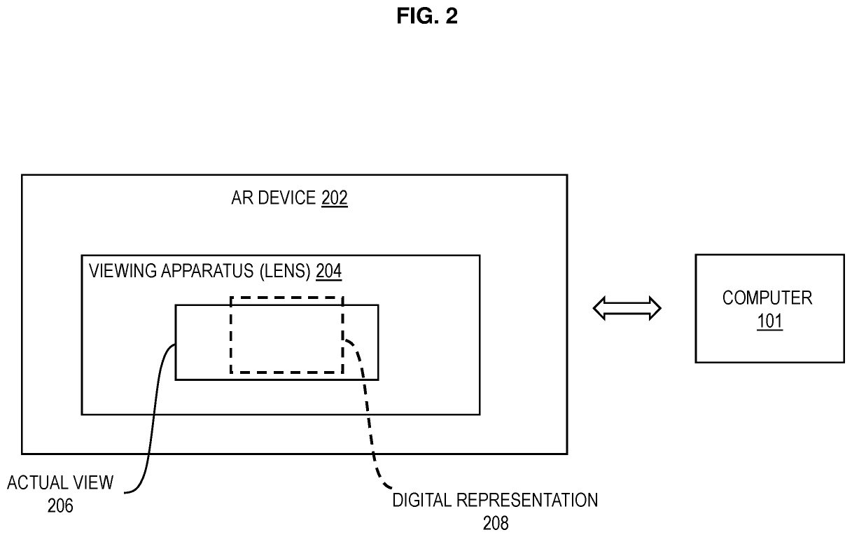

FIG. 2 depicts the computing environment 100 with further details for providing augmented reality based comparative learning of machine functionality according to one or more embodiments. In FIG. 2 and other figures herein, some details of the computing environment 100 may be omitted so as not to obscure the figure while new details are presented.

In FIG. 2, the computing environment 100 includes an AR device 202 having a viewing apparatus 204. Using the viewing apparatus 204, the AR device 202 is configured to display a digital representation 208 of an old technology, for example, an old machine, overlaid on an actual view 206 of a new technology, for example, a new machine. The viewing apparatus 204 shows the actual view 206 of the new technology in the real world. The real world can be utilized interchangeably with the physical surrounding, real environment, physical world, etc. The actual view 206 presents the real world in which the user of the AR device 202 can physically touch while wearing the AR device 202. Moreover, the user can physically touch any object in the real world both wearing and not wearing the AR device 202. Using the AR device 202, the digital representation 208 is overlaid on the actual view 206 such that the user can concurrently view the digital representation 208 and the actual view 206 of new technology while physically interacting with the new technology. Unlike the new technology in the actual view 206, the user cannot physically touch the digital representation 208 displayed in the viewing apparatus.

The AR device 202 can communicate with the computer 101 to obtain the digital representation 208 along with processes associated with the digital representation 208. The terms processes and actions may be utilized interchangeably to represent the steps or procedures performed on or using a machine. The digital representation 208 can be pushed to the AR device 202 from the computer 101, and/or the digital representation 208 can be pulled by the AR device 202 from the computer 101. In one or more embodiments, the digital representation 208 may be already present on the AR device 202.

For ease of understanding, various scenarios may discuss examples overlaying the digital representation 208 of an old machine over the actual view 206 of the new machine in order for the user of the AR device 202 to view execution of a sequence of steps for the previous action on the old machine as the digital representation 208 while concurrently viewing the actual view 206 of the new machine in the real world. It should be appreciated that embodiments are not limited to various scenarios discussed herein. In one or more embodiments, the actual view 206 may be the old machine of old technology that is physically present in the real world, and the digital representation 208 may be for a new machine of new technology that is displayed in the viewing apparatus 204. In this case, the digital representation 208 of the new machine is overlaid over the actual view 206 of the old machine in order for the user of the AR device 202 to view execution of a sequence of steps for the new action on the new machine while concurrently viewing the old machine in the real world.

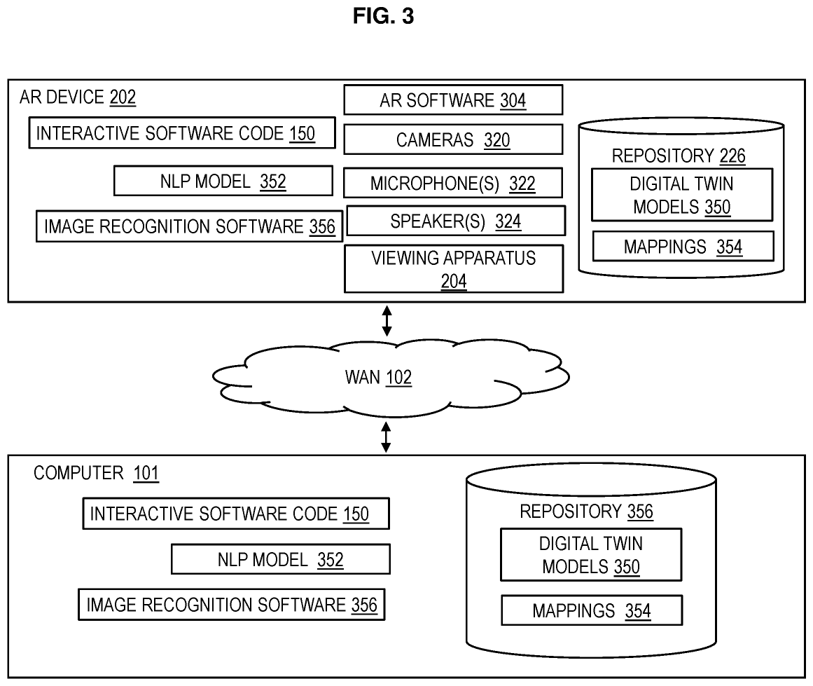

FIG. 3 depicts a block diagram of an example computing environment 100 for augmented reality based comparative learning of machine functionality according to one or more embodiments. In FIG. 3, the AR device 202 includes and/or is coupled to one or more cameras 320, microphones 322, and speakers 324. The AR device 202 can include AR software 304 for operating the normal functions of an augmented reality device as understood by one of ordinary skill in the art. In one or more embodiments, the AR device 202 may include glasses, goggles, and/or a head mounted unit in which the wearer can view the real world unobstructed through the viewing apparatus 204.

In addition to displaying digital representations as a display screen, the viewing apparatus 204 shows objects within a field-of-view using transparent lenses. The terms “lens” or “lenses” are utilized as broadly encompassing any type of transparent or semi-transparent pane, sheet, or film made up of at least one type of material. The terms “lens” and “lenses” may include more than a single pane, sheet, or film, including combinations therein pressed or stacked together. A lens may be constructed out of multiple pieces of material, such as glass and microscopic circuits, in order to display the digital representation 208 over the actual view 206 of the real world. A lens may include a single piece of glass, for example, or may comprise a transparent capacitive touch screen with microscopic sensors embedded within it. Alternatively, and/or additionally, a lens may be a single piece of glass with a capacitive film attached to the glass. Also, the user may touch the lens of the viewing apparatus to interact with the AR device 202 and/or touch any buttons on the frame of the AR device 202 when implemented as, for example, glasses, goggles, etc. Using the microphone 322 coupled to the AR device 202, the user can speak instructions and commands to interact with the AR device 202.

Although not shown for the conciseness, the AR device 202 can include any of the functionality discussed in FIG. 1 for the computer 101. The AR device 202 can include processing circuitry 120 of the processor set 110 in which computer readable program instructions are performed by processor set 110 such that the instructions thus executed will instantiate the methods specified in flowcharts and/or narrative descriptions of computer-implemented methods included in this document (collectively referred to as “the inventive methods”). Moreover, the AR device 202 may include any of the hardware or software of computer 101 discussed in FIG. 1. The AR device 202 may include interactive software code 150 for causing display of a digital representation 208 of the old technology overlaid over the actual view 206 of the new technology on the viewing apparatus 204 or vice versa, in accordance with one or more embodiments. The interactive software code 150 can work in cooperation with the AR software 304. The interactive software code 150 can be a be plug-in or an application that operates with the AR software 304. The interactive software code 150 can be an update to the AR software 204. The interactive software code 150 can include one or more application programming interfaces (API) for operating as discussed herein. The digital representation 208 can be a digital twin or digital twin model of a physical object in the real world, where the digital representation 208 is obtained from numerous digital twin models 350 in a repository 256 of the AR device 202 and/or a repository 356 in the computer 101. A digital twin is a virtual representation of an object or system that spans its lifecycle, is updated from real-time data, and uses simulation, machine learning, and reasoning to help decision-making.

Further, one of ordinary skill in the art understands digital twins, and embodiments are configured to utilize known technology for digital twins. Moreover, a digital twin is a digital representation of an intended or actual real world physical product, system, or process (a physical twin) that serves as the effectively indistinguishable digital counterpart of it for practical purposes, such as simulation, integration, testing, monitoring, and maintenance. The digital twin has been intended from its initial introduction to be the underlying premise for product lifecycle management and exists throughout the entire lifecycle (create, build, operate/support, and dispose) of the physical entity it represents. Since information is granular, the digital twin representation is determined by the value-based use cases it is created to implement. The digital twin can and does often exist before there is a physical entity. The use of a digital twin in the create phase allows the intended entity's entire lifecycle to be modeled and simulated. A digital twin of an existing entity can be used in real time and regularly synchronized with the corresponding physical system.

The AR device 202 may include a natural language processing (NLP) model 352 and/or be coupled to the NLP model 352 to assist the operator of a machine. The NLP model 352 is configured to receive inquiries from the operator and perform actions based on interpretating the user's request. The inquiry can be to teach the user how to perform a process on the new machine in the real word using a process from the old machine as a digital representation. The inquiry can be verbal, textual, graphical, etc.

It is noted that the AR device 202 can communicate with the computer 101 over the WAN 102 in order to have some functions performed by the computer 101. The computer 101 can include the repository 356, the NLP model 352, and/or the interactive software code 150. In one or more embodiments, the AR device 202 can communicate with the computer 101 to access the repository 356, the NLP model 352, and/or functionality, or at least partial functionality, of the interactive software code 150.

In some example scenarios, an original process and original machine can be referred to as an old process and old machine, where the old process performed using the old machine is being transitioned to a new process using a new machine. These example scenarios are for explanation purposes, and embodiments are not meant to be limited. Again, the terms process and action may be utilized interchangeably as having procedures or steps that are performed on the machine, which can be the old or new machine. In one or more embodiments, there can be different versions or model of the machine, and embodiments can be utilized to assist the user to learn a new version or model of the machine as discussed herein.

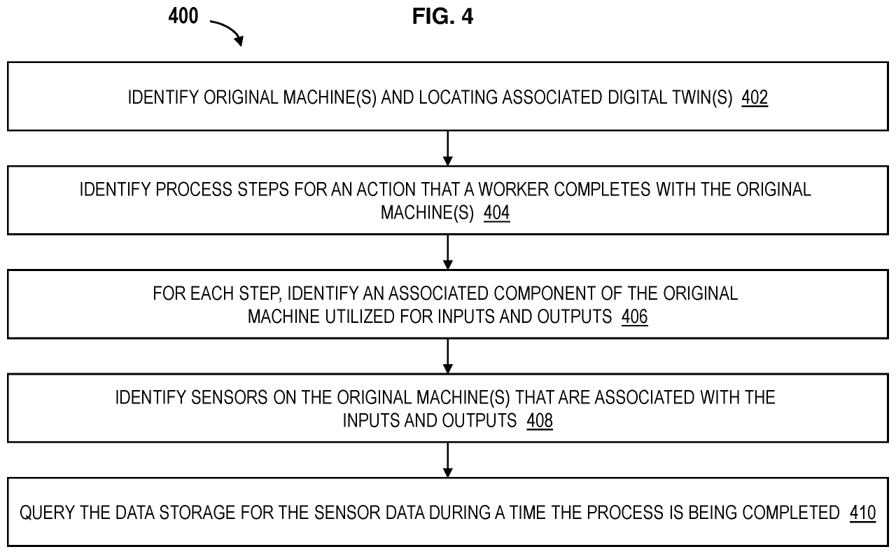

FIG. 4 is a flowchart of a computer-implemented method 400 for determining an original process for an original machine according to one or more embodiments.

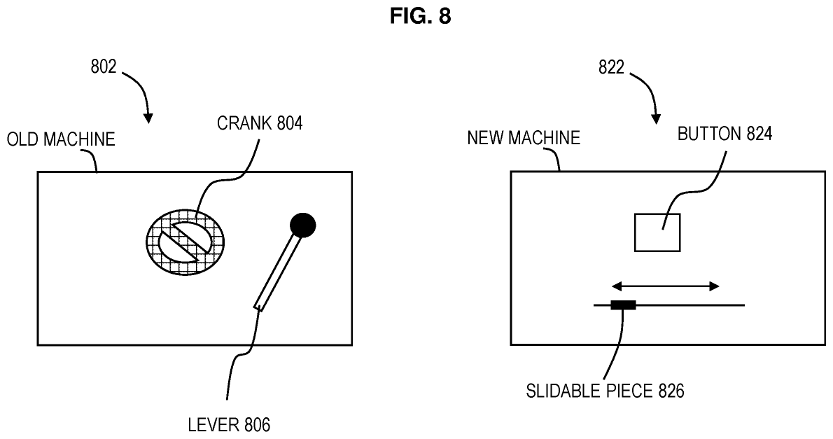

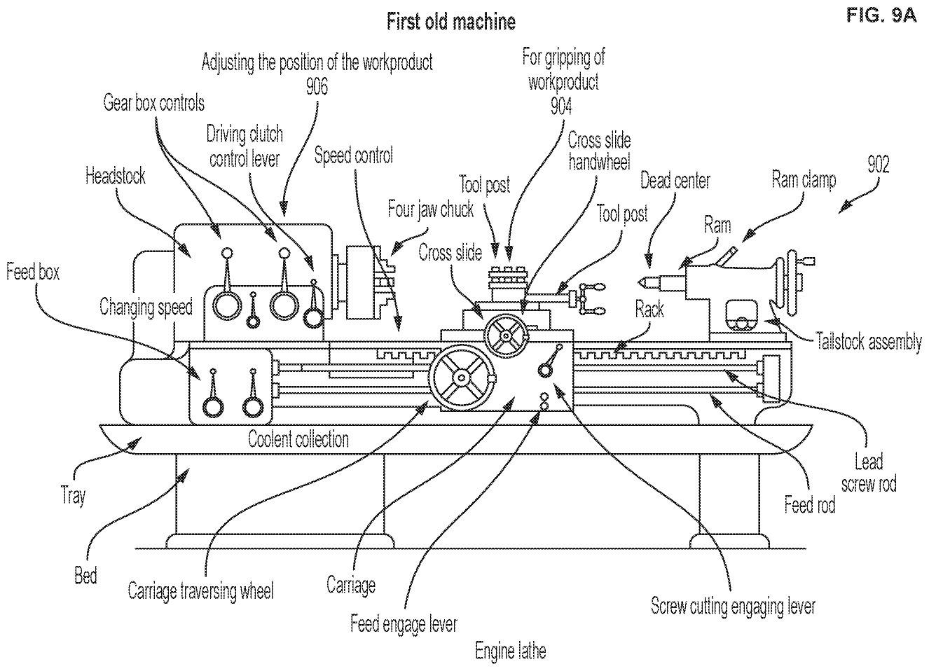

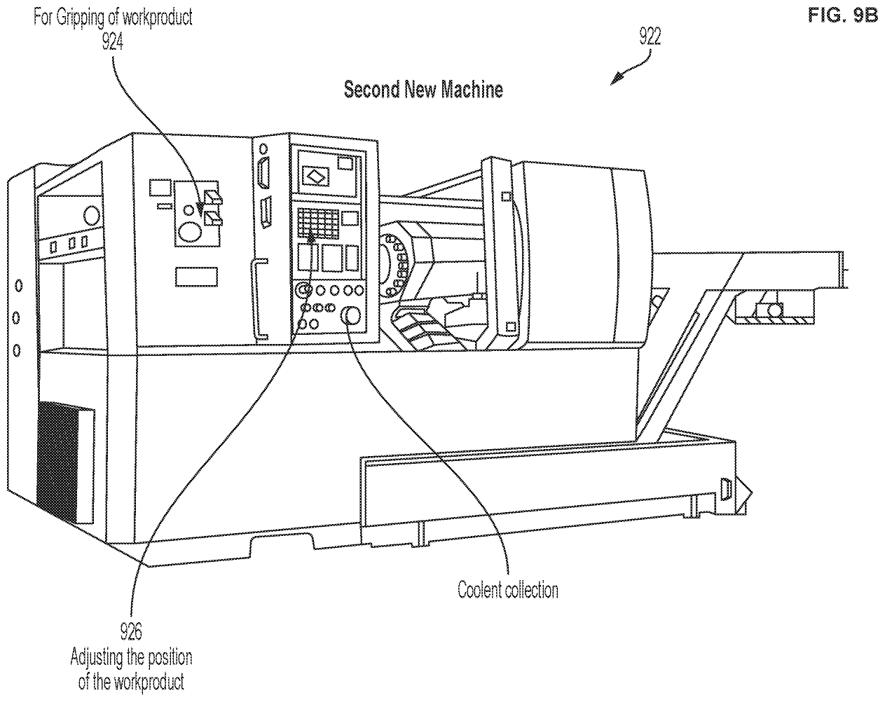

At block 402, the interactive software code 150 is configured to identify an original machine and locate its associated digital twin. A user can input the identification of the original machine, which can be a name, identification number, code, model number, version number, etc., that is assigned to and used to identify the original machine. The interactive software code 150 is configured to search the digital twin models 350 in repository 256 for the associated digital twin model that represents the original machine. FIG. 8 depicts a block diagram of a simplified example old or original machine 802 and an example new machine 822. It should be appreciated that the example machines in FIG. 8, as well as FIGS. 9A and 9B, are for explanation purposes and are not meant to be limiting.

At block 404, the interactive software code 150 is configured to identify the steps for a process that the worker has performed with the original machine. The steps can be discovered by ingestion of training or process manuals identifying the steps for the process of the original machine 802. The interactive software code 150 can identify the steps using the digital twin model to recognize the component being used and confirm that component against the ingested steps of the manuals and/or video when available. Additionally, in one or more embodiments, image recognition software 346 can be used to augment or replace the ingested steps by analyzing the worker on video to match the actual steps practiced which may differ from the documentation. The image recognition software 346 is a computer program that can identify an object, scenes, people, text, and/or activities in images and videos. The image recognition software 346 can include trained machine learning models such as neural networks particularly convolution neural networks, as understood by one of ordinary skill in the art.

At block 406, the interactive software code 150 is configured to, for each step, identify the components of the original machine utilized for inputs and outputs. The component are the controls utilized to control operation of the machine. In FIG. 8, example components in the original machine 802 may include one or more cranks 804, one or more levers 806, etc. The input may be a sheet of metal and operation of the component causes the metal to be heated and stamped with a die, while the output is multiple cut metal pieces. At block 408, the interactive software code 150 is configured to identify sensors on the original machine that are associated with the inputs and outputs, and identify data storage locations for the sensor data of the inputs and outputs. The data storage could be the repository 256 or the repository 356. At block 410, the interactive software code 150 is configured to query the data storage for the sensor data during a time that the process is being completed. In one or more embodiments, the interactive software code 150 can map an old process (and its old steps) of the original machine 802 (or original machine 902 depicted in FIG. 9A) to a new process (and its new steps) of the new machine 822 (or new machine 922 depicted in FIG. 9B) by matching the input and output of the old machine to the same or equivalent input and output of the new machine. This mapping of equivalent inputs and outputs for the two machines can be stored in the mappings 354.

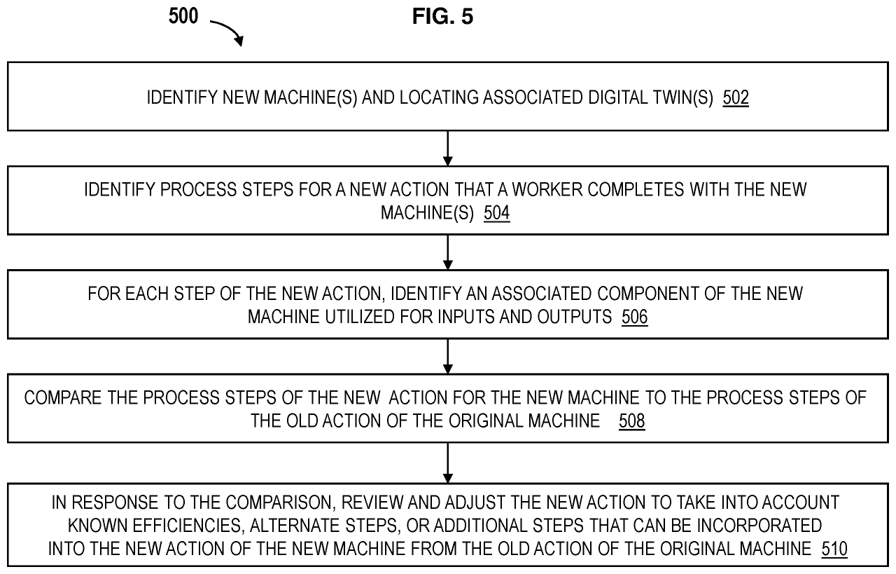

FIG. 5 is a flowchart of a computer-implemented method 500 for determining a new process for the new machine according to one or more embodiments.

At block 502, the interactive software code 150 is configured to identify the new machine and locate its associated digital twin. A user can input the identification of the original machine, which can be a name, identification number, code, model number, version number, etc., that is assigned to and used to identify the new machine. The interactive software code 150 is configured to search the digital twin models 350 in repository 256 for the associated digital twin model that represents the new machine, for example, new machine 822 or new machine 922.

At block 504, the interactive software code 150 is configured to identify the steps for a new process that the worker is to perform with the new machine. The steps can be discovered by ingestion of new training or process manuals identifying the steps for the process of the new machine 822. Using the NLP model 352, the interactive software code 150 can identify the components used in each ingested step and relate that to the components shown in the digital twin model. Additionally, an initial worker can learn how to use the new machine and be guided through the steps to provide a video archive that can be used to create the new process similar to harvesting the old process. When new steps are not available, the interactive software code 150 can emulate the set of old steps discovered on the original machine 802 and identify from the digital twin model of the old machine which components provide the corresponding functions of the steps on the original machine 802. Even if the old steps are somewhat different from the new steps, the input and output of the new machine 822 are determined to be equivalent to the same input and output of the old machine 802, such that old components utilized in the old process to result in the output (given the input) can be mapped to the corresponding new components in the new process that result in the same output (given the input).

At block 506, the interactive software code 150 is configured to, for each step of the new process, identify an associated component of the new machine utilized for inputs and outputs. There can be one or more inputs and outputs for the new machine, and the interactive software code 150 finds the inputs and outputs along with the components that are operated for the inputs and outputs of the new machine. At block 508, the interactive software code 150 is configured to compare the new steps (using the new components) of the new process for the new machine to the old steps (using the old components) of the old machine.

The interactive software code 150 may call or employ the NLP model 352. The NLP model 352 can be instructed by the interactive software code 150 to search for and find the equivalence of terminology between the digital twin models (of the original machine 802 and the new machine 822) in order to identify components that perform the same/similar functions. The NLP model 352 can be instructed by the interactive software code 150 to search for and find the equivalence of terminology for inputs and outputs between the digital twin models (of the original machine 802 and the new machine 822) in order to identify an equivalent old process and equivalent new process that perform the same/similar functions. In mappings 354, which could be a mappings database or listing, an old process performed on an original machine is mapped to a new process performed on a new machine. Using the mappings 354, the interactive software code 150 can select an equivalent process performed on the new machine 822, where the equivalent process is a new process equivalent to the old process on the original machine 802. For example, the old process having one or more old steps and the old components of the original machine 802 utilized to perform the old process are mapped to the new process having one or more new steps and the new components of the new machine 822 utilized to perform the new process. As simplified examples for illustration purposes, a mapping in the mappings 354 can link an old process and one or more old components, for example, a crank 804 on the original machine 802 to an equivalent new process and equivalent new component, for example, a button 824 on the new machine 822. As an example, an old process performed on the original machine 802 might require the crank 804 to be turned and then a lever 806 to be pulled, while the equivalent process performed on the new machine 822 requires the button 824 to be pushed in and a slidable piece 826 to be slid (e.g., left to right or right to left).

Referring to FIG. 5, at block 510, in response to completing the comparison, the interactive software code 150 is configured to review and adjust the new process to take into account known efficiencies, alternate steps, and/or additional steps that can be incorporated into the new process of the new machine from the old process of the original machine. This may be particularly useful when no ingested steps were involved for the new process of the new machine. This may also serve as a sanity check.

As discussed herein, the worker is habituated to work on old machine, and now the worker is required to work on a new machine, where the new machine has advanced technology and thus requires a new way of performing the activity. The same outcome can be achieved with the new machine by performing the process in different way as discussed herein. According to one or more embodiments, the interactive software code 150 performs comparative digital twin simulation between the old machine and the new machine, and the interactive software code 150 can overlay the comparative information on the new machine so that the worker can quickly learn the new machine. This example scenario continues below.

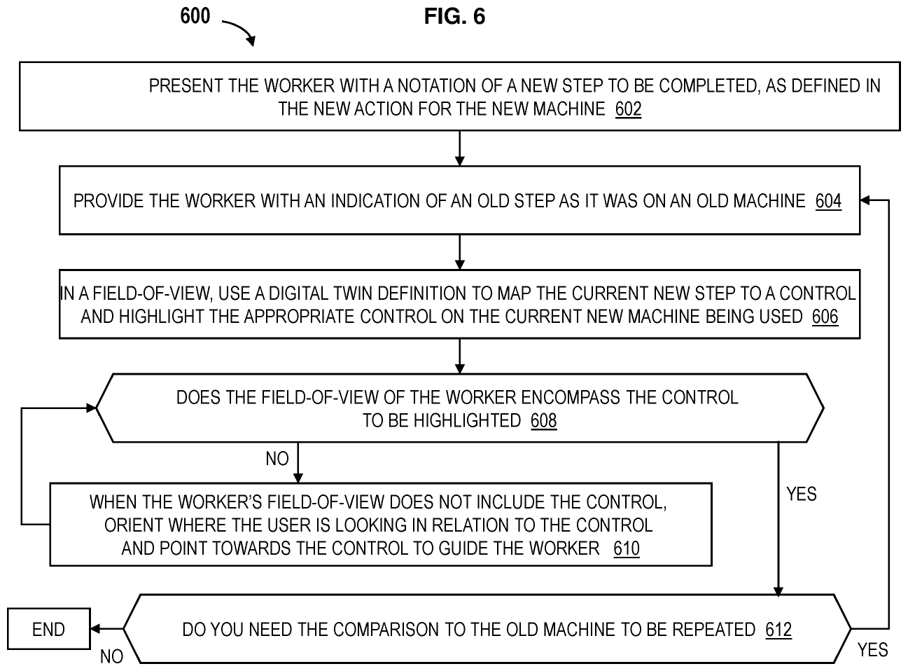

FIG. 6 is a flowchart of a computer-implemented method 600 for guiding a worker to operate a machine by providing augmented reality based comparative learning of machine functionality according to one or more embodiments. During the period of training the worker on the new machine, the user may take advantage of augmented reality to contextualize the use of the new machine as compared to the old machine in accordance with one or more embodiments. Although the AR device 202 is commonly thought of as a heads-up display for eyewear, the augmented reality may be communicated in alternate augmented methodologies as well. In the example scenario, it is assumed that the new machine is physically present with the worker in the real world as the worker is being trained.

At block 602, the interactive software code 150 is configured to present the worker with a notation of a step to be completed, as defined in the new process. The interactive software code 150 can cause the display of the notation on the viewing apparatus 204 of the AR device 202. The notation can include a textual description of the new process and/or the new step in the new process. The notation can include a visual representation, such as an icon representing the new process and/or the new step in the new process. Additionally, the interactive software code 150 can cause the notation to be audibly output as the description of the new process and/or the new step in the new process through speakers 324 of the AR device 202.

In one or more embodiments, the worker wearing the AR device 202 may inquire how do a perform the new process X on the new machine. In one or more embodiments, the worker can verbally inquire how to perform the new process on the new machine 822 or 922 using the microphone 322 of the AR device 202, which is then process by the NLP model 352 after conversion from speech-to-text. In one or more embodiments, the user can input text and/or make a selection in a graphical user interface (GUI) of the AR device 202 to inquire how to perform the new process on the new machine 822 or 922. In one or more embodiments, the worker can stand in front of the new machine with the camera 320 capturing the new machine, and the interactive software code 150 recognizes captured images/video as being the new machine in repository 226 or repository 356 using image recognition software 346.

At block 604, the interactive software code 150 is configured to display on the viewing apparatus 204 to the worker a presentation of the old steps for the old process on the old machine. The interactive software code 150 can search the mappings 354 for a mapping of the old machine 802 to the new machine 822. The presentation on the AR device 202 can be the digital representation 208 of original machine 802 in which the old step(s) of the old process is performed using the equivalent old component, for example, the crank 804 and/or the lever 806, on the original machine 802. This digital representation 208 of the old steps for the old machine is overlaid on the actual view 208 of the new machine 822 in the real world.

The AR device 202 also displays an indication that the step(s) is for the process on the old machine as appropriate. The digital representation 208 of the original machine 802 displayed on the AR device 202 can be a digital twin model/image of the old machine with the related old components highlighted. The highlighted old component can be the crank 804 and/or the lever 806 of the original machine 802. Alternatively, and/or additionally, the presentation on the AR device 202 can be an image/video from a learning corpus of the worker actually performing the steps on the old machine. The image/video of the worker may be retrieved from the repository 256 or repository 356.

At block 606, the interactive software code 150 is configured to, in a field-of-view of the work, use the digital twin model of the new machine 822 to map the (current) new step to the corresponding component on the new machine 822. The interactive software code 150 can select the digital twin model of the new machine 822 from the digital twin models 350 and display the highlighted new component, for example, the button 824 and/or slidable piece 826 utilized to perform the equivalent new step of the new process on the new machine 822. In one or more embodiments, the highlighted new component of the digital twin model can be displayed as another digital representation 208 of the new machine 822 in the viewing apparatus 204.

At block 608, the interactive software code 150 is configured to check whether the field-of-view of the real world encompass the new component of the new process utilized to perform the new step(s) of the new process. The camera 320 of the AR device 202 can capture images and/or video of the field-of-view that is seen by the worker through the viewing apparatus 204. The interactive software code 150 can cause image recognition software 346 to compare the captured images/videos of the new machine 822 to previously stored images/videos and/or the digital twin model of the new machine 822 in order to determine if the captured images/videos by the camera 320 contain the new component of the new process.

At block 610, when (No) the worker's current field-of-view does not include the new component (e.g., button 824 and/or slidable piece 826) of the new machine 822, the interactive software code 150 is configured to orient the field-of-view where the user is looking in relation to the new component and point/direct the field-of-view of the user toward the new component in order to guide the worker. In one or more embodiments, a visual guide is displayed to orient the field-of-view of the user to the new component on the new machine 822 such that both the old process using the old component in the digital representation 208 and the new component in the actual view are viewable on the AR device 202. In one or more embodiments, the guide can be an audible voice providing instructions to guide the worker in the correct direction based on the captured images/video of the new machine 822. In one or more embodiments, the guide can be a graphical display such as arrows, lights, signs, etc., to guide the worker in the correct direction, in addition to the audible guide. It is noted that blocks 608 and 610 can be performed earlier or at any stage such as in response to blocks 602, 604, 606, or 612.

At block 612, when (Yes) the worker's current field-of-view in the viewing apparatus 204 of the AR device 202 does encompass the new component on the new machine 822, the interactive software code 150 is configured to check does the worker need to repeat the comparison to the old machine 802. If (No) not, the flow ends. If (Yes) the worker confirms verbally using the microphone 322 and/or confirms using a touch screen on the viewing apparatus 204, the flow returns to block 604.

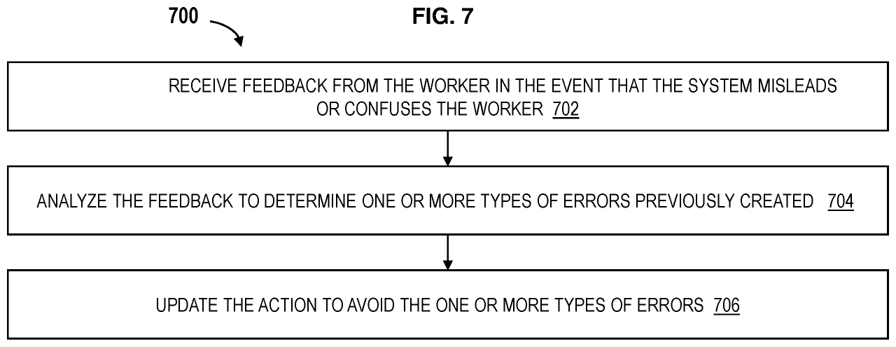

FIG. 7 is a flowchart of a computer-implemented method 700 for further defining the new process on the new machine according to one or more embodiments.

At block 702, the interactive software code 150 is configured to receive feedback from the work in the event that the interactive software code 150 misleads or confuses the worker. At block 704, the interactive software code 150 is configured to analyze the feedback to determine one or more types of errors that have been previously created. At block 706, the interactive software code 150 is configured to update the new process to avoid the one or more types of errors.

FIGS. 9A and 9B illustrate an example original machine 902 and an example new machine 922 according to one or more embodiments. As a digital representation 208 displayed on the viewing apparatus 204, an old process is overlaid utilizing a component 904 for gripping a work product on the original machine 902, while the field-of-view of the viewing apparatus 204 encompasses the actual view 206 in the real world of the (highlighted) new equivalent component 924 for gripping the work product on the new machine 922. Also, as the digital representation 208, an old process is overlaid utilizing a component 906 for adjusting the position of the work product on the original machine 902, while the field-of-view of the viewing apparatus 204 encompasses the actual view 206 in the real world of the (highlighted) new equivalent component 926 for adjusting the work product on the new machine 922.

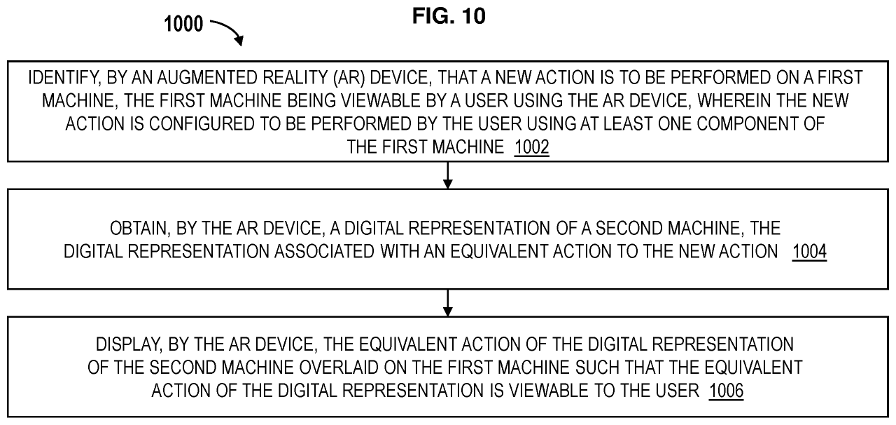

FIG. 10 is a flowchart of a computer-implemented method 1000 for providing augmented reality based comparative learning of machine functionality according to one or more embodiments.

At block 1002 of the computer-implemented method 1000, the augmented reality (AR) device 202 is configured to identify that a new action is to be performed on a first machine (e.g., a new process is to be performed on the new machine 822 or new machine 922), the first machine being viewable by a user using the AR device 202, where the new action is configured to be performed by the user using at least one component of the first machine. For example, the new machine 822 has example component 824 and component 826, and the new machine 922 has example component 924 and component 926. The new machine 822 or 922 is seen as the actual view 206 in the real world through, for example, the lens of the viewing apparatus 204.

At block 1004, the AR device 202 is configured to obtain a digital representation 208 of a second machine, the digital representation 208 being associated with an equivalent action (e.g., an old process of the original machine 802 or original machine 902) to the new action (e.g., the new process to be performed on the new machine 822 or new machine 922). A first outcome of the new action (e.g., new process) and a second outcome of the equivalent action (e.g., old process) are determined to be equivalent by the interactive software code 150, which are stored in the mapping of the mappings 354. Further, the inputs of the new action (new process) and the equivalent action (e.g., old process) are determined to be equivalent by the interactive software code 150, which are stored in the mapping of the mappings 354.

At block 1006, the AR device 202 is configured to display the equivalent action of the digital representation 208 of the second machine overlaid on the first machine such that the equivalent action of the digital representation is viewable to the user. For example, the viewing apparatus 204 can display the old process of the original machine 802 or 902 as the digital representation 208 overlaid on the actual view 206 of the new machine 822 or 922.

Further, in one or more embodiments, at least one equivalent component of the second machine is mapped to the at least one component of the first machine. Example equivalent component 804 and/or 806 of the original machine 802 is mapped to at least one component 824 and/or 826 of the new machine 822 in a mapping or computer-executable file in the mappings 354. Example equivalent component 904 and/or 906 of the original machine 902 is mapped to at least one component 924 and/or 926 of the new machine 922 in a mapping or computer-executable file in the mappings 354.

The new action includes a first plurality of procedures performed on the first machine and the equivalent action includes a second plurality of procedures performed on the second machine, at least one of the second plurality of procedures being different from the first plurality of procedures. For example, the new process includes first steps performed on the new machine 822 or 922, while the equivalent action (e.g., old process) includes second steps performed on the original machine 802 or 902 (e.g., old machine).

Performing the second plurality of procedures of the equivalent action using the at least one equivalent component (e.g., equivalent component 804 and/or 806, or equivalent component 904 and/or 906) are displayed on the AR device 202 along with a view of the at least one component (e.g., at least one component 824 and/or 826, or at least one component 924 and/or 926).

In response to a field-of-view of the AR device 202 excluding the at least one component of the first machine, a guide is displayed to orient the field-of-view of the user to the at least one component on the first machine such that both the equivalent action of the digital representation and the at least one component are viewable on the AR device 202. In one or more embodiments, the guide can be an audible voice providing instructions to guide the worker in the correct direction. In one or more embodiments, the guide can be a graphical display such as arrows, lights, signs, etc., to guide the worker in the correct direction.

Further, the first machine (e.g., the new machine 822 or 922) is physically viewable (e.g., in the actual view 206) through the AR device 202. The second machine (e.g., original machine 802 or 902) is virtually displayed as the digital representation 208 by the AR device 202 in a same field-of-view as the at least one component (e.g., at least one component 824 and/or 826, or at least one component 924 and/or 926) of the first machine.

Additionally, identifying that the new action (e.g., new process) is to be performed on the first machine is in response to the user inquiring how to perform the new action on the first machine in relation to the second machine. In one or more embodiments, the user can verbally inquire how to perform the new process on the new machine 822 or 922 using the microphone 322, which is then process by the NLP model 352 after conversion from speech-to-text. In one or more embodiments, the user can input text and/or make a selection in a graphical user interface (GUI) to inquire how to perform the new process on the new machine 822 or 922. Feedback from the user is received regarding a plurality of procedures of the at least one equivalent action being unsuccessful to assist the user with performing the new action, and updates to the plurality of procedures of the at least one equivalent action are made in response to the feedback, as discussed in FIG. 7.

As technical effects and solutions, one or more embodiments use digital twin simulation of any old machine, and the discloses system identifies how different functionalities/activities are executed and what are the outcome of the activities with old machines. Accordingly, the disclosed system identifies how those activity outcomes can be achieved with the new machine, what functionalities/activities are to be executed on the new machine, and the same is overlaid over the AR device. When training the worker of operations of the new machine, the AR device is overlaying how the worker used to perform the activity or how the same outcome used to be obtained from old machine; as such, the worker is able to map his knowledge between the old machine and the new machine, to learn the new machine. Further, while the worker looks at new machine, the AR device is receiving a comparative digital twin simulation result between the old machine and the second new machine. Accordingly, the disclosed system uses the AR device to show which old way of performing the activity is not required, which additional activity is to be performed, and which activities remain the same. In one or more embodiments, the disclosed system compares the level of difference between old way of performing any activity (or expected outcome) with old machine and a new way of performing the same activity (or expected outcome) in new machine; the disclosed system then identifies where the learning will be more intense and where learning will be less, all of which is shown on the AR device. The disclosed system can use the IoT and image feed analysis of the worker's activity to identify how the worker previously perform different activities with different types of old machines; accordingly, the disclosed system identifies the knowledge level of the worker in the old way of performing the activities in different old machines, and the same is compared with the new way of performing the activity with the new machine to identify which worker can quickly learn the new activity with the second new machine. In one or more embodiments, the disclosed system provides resiliency. This accomplished by mimicking one capability to another to introduce resiliency in the latter. In doing so, the confidence level of delivering the desired capability is achieved. In mimicking the one process with the other, a detection method for adverse events is established. This can be further enhanced by instilling a recovery schema for classes of events of a certain type.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
identifying, by an augmented reality (AR) device, that a new action is to be performed on a first machine, the first machine being viewable by a user using the AR device, wherein the new action is configured to be performed by the user using at least one component of the first machine;
obtaining, by the AR device, a digital representation of a second machine, the digital representation being associated with an equivalent action to the new action, wherein a first outcome of the new action and a second outcome of the equivalent action are determined to be equivalent; and
displaying, by the AR device, the equivalent action of the digital representation of the second machine overlaid on the first machine such that the equivalent action of the digital representation is viewable to the user.

2. The computer-implemented method of claim 1, wherein at least one equivalent component of the second machine is mapped to the at least one component of the first machine.

3. The computer-implemented method of claim 1, wherein the new action comprises a first plurality of procedures performed on the first machine and the equivalent action comprises a second plurality of procedures performed on the second machine, at least one of the second plurality of procedures being different from the first plurality of procedures.

4. The computer-implemented method of claim 3, wherein performing the second plurality of procedures of the equivalent action using the at least one equivalent component is displayed along with a view of the at least one component.

5. The computer-implemented method of claim 1, wherein, in response to a field-of-view excluding the at least one component of the first machine, a guide is displayed to orient the field-of-view of the user to the at least one component on the first machine such that both the equivalent action of the digital representation and the at least one component are viewable on the AR device.

6. The computer-implemented method of claim 1, wherein:
the first machine is physically viewable through the AR device; and
the second machine is virtually displayed by the AR device in a same field-of-view as the at least one component of the first machine.

7. The computer-implemented method of claim 1, wherein:
identifying that the new action is to be performed on the first machine is in response to the user inquiring how to perform the new action on the first machine in relation to the second machine;
feedback from the user is received regarding a plurality of procedures of the at least one equivalent action being unsuccessful to assist the user with performing the new action; and
updates to the plurality of procedures of the at least one equivalent action are made in response to the feedback.

8. A system of an augmented reality (AR) device comprising:
a memory having computer readable instructions; and
a computer for executing the computer readable instructions, the computer readable instructions controlling the computer to perform operations comprising:
identifying that a new action is to be performed on a first machine, the first machine being viewable by a user using the AR device, wherein the new action is configured to be performed by the user using at least one component of the first machine;
obtaining a digital representation of a second machine, the digital representation being associated with an equivalent action to the new action, wherein a first outcome of the new action and a second outcome of the equivalent action are determined to be equivalent; and
displaying the equivalent action of the digital representation of the second machine overlaid on the first machine such that the equivalent action of the digital representation is viewable to the user.

9. The system of claim 8, wherein at least one equivalent component of the second machine is mapped to the at least one component of the first machine.

10. The system of claim 8, wherein the new action comprises a first plurality of procedures performed on the first machine and the equivalent action comprises a second plurality of procedures performed on the second machine, at least one of the second plurality of procedures being different from the first plurality of procedures.

11. The system of claim 10, wherein performing the second plurality of procedures of the equivalent action using the at least one equivalent component is displayed along with a view of the at least one component.

12. The system of claim 8, wherein, in response to a field-of-view excluding the at least one component of the first machine, a guide is displayed to orient the field-of-view of the user to the at least one component on the first machine such that both the equivalent action of the digital representation and the at least one component are viewable on the AR device.

13. The system of claim 8, wherein:
the first machine is physically viewable through the AR device; and
the second machine is virtually displayed by the AR device in a same field-of-view as the at least one component of the first machine.

14. The system of claim 8, wherein:
identifying that the new action is to be performed on the first machine is in response to the user inquiring how to perform the new action on the first machine in relation to the second machine;
feedback from the user is received regarding a plurality of procedures of the at least one equivalent action being unsuccessful to assist the user with performing the new action; and
updates to the plurality of procedures of the at least one equivalent action are made in response to the feedback.

15. A computer program product comprising a computer readable storage medium having program instructions embodied therewith, the program instructions executable by a computer to cause the computer to perform operations comprising:
identifying that a new action is to be performed on a first machine, the first machine being viewable by a user using an augmented reality (AR) device, wherein the new action is configured to be performed by the user using at least one component of the first machine;
obtaining a digital representation of a second machine, the digital representation being associated with an equivalent action to the new action, wherein a first outcome of the new action and a second outcome of the equivalent action are determined to be equivalent; and
displaying the equivalent action of the digital representation of the second machine overlaid on the first machine such that the equivalent action of the digital representation is viewable to the user.

16. The computer program product of claim 15, wherein at least one equivalent component of the second machine is mapped to the at least one component of the first machine.

17. The computer program product of claim 15, wherein the new action comprises a first plurality of procedures performed on the first machine and the equivalent action comprises a second plurality of procedures performed on the second machine, at least one of the second plurality of procedures being different from the first plurality of procedures.

18. The computer program product of claim 17, wherein performing the second plurality of procedures of the equivalent action using the at least one equivalent component is displayed along with a view of the at least one component.

19. The computer program product of claim 15, wherein, in response to a field-of-view excluding the at least one component of the first machine, a guide is displayed to orient the field-of-view of the user to the at least one component on the first machine such that both the equivalent action of the digital representation and the at least one component are viewable on the AR device.

20. The computer program product of claim 15, wherein:
the first machine is physically viewable through the AR device; and
the second machine is virtually displayed by the AR device in a same field-of-view as the at least one component of the first machine.
